(19) United States
(12) Patent Application Publication
(10) Pub. No.: US 2006/0009937 A1
(43) Pub. Date: Jan. 12, 2006

(54) Automatic calibration of sensors attached to a computer's game port

(76) Inventor: Michael W. Bigrigg, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/888,395

(22) Filed: Jul. 9, 2004

(51) Int. Cl. G01C 25/00; G01C 19/00

(52) U.S. Cl. 702/104; 702/186

(57) ABSTRACT

A system and method to automatically calibrate resistance-based sensors connected to a first joystick input on a computer game port adapter by affixing known resistances to a second joystick input on the game port adapter is disclosed. The corresponding software establishes a first relationship between the known resistances and corresponding adapter voltages (as represented by respective pulse counts). Based on this relationship, the software automatically calibrates the sensor attached to the game port adapter using a variable voltage signal (and corresponding variable pulse count) generated by the sensor due to the variations in the sensor resistance based on an environmental condition (e.g., temperature, humidity, etc.) being monitored by the sensor. The sensor's variable resistance value is calculated based on the sensor voltage input and the first relationship. The current environmental condition associated with the calculated resistance value is determined by consulting the manufacturer's specification sheet for the sensor. The software also enables the computer to display the value of the current environmental condition sensed by the sensor. Because of the rules governing abstracts, the present abstract should not be used to construe claims.

### BACKGROUND

This disclosure relates generally to measuring environmental conditions such as temperature, humidity, illumination intensity, etc. and, more particularly, measuring such conditions with a personal computer (PC).

It is known that PCs support various peripheral devices such as, for example, a joystick. A joystick is an analog device typically comprised of two potentiometers with variable resistance values of between 0 ohm and 100 k ohm. The potentiometer's resistances have a minimum value when the joystick is at the top left position. These variable, analog resistance values must be converted to digital signals to be used by the PC.

To convert the analog outputs of the joystick's potentiometers to digital signals, conversion hardware is needed. On newer PCs, the necessary hardware needed to interface with a joystick may be provided on a multifunction card or board. On older PCs, a dedicated joystick card or game board may be provided. Regardless of whether the interface is implemented in a combined or dedicated manner, the resistance value of the joystick's potentiometers are measured using a very simple monostable multivibrator circuit, where a small capacitor is charged through the joystick's potentiometers to a certain voltage level. A typical joystick interface has 4 monostable multivibrators, usually in a single integrated circuit. Normally, in the idle state, the capacitor is fully charged and the multivibrator output is at a logic 1. The processor of the PC sends an instruction to the interface to reset the multivibrators. Upon receiving the instruction, each multivibrator discharges its associated capacitor. The multivibrator's output goes to logic 0 because the capacitor has been discharged. The capacitor then starts to charge from the current flowing through the joystick's potentiometer. When the capacitor voltage reaches a certain threshold level, the multivibrator output returns to a logic 1.

The larger the potentiometer resistance value, the longer it takes for the capacitor to reach the threshold voltage. The time it takes for the multivibrator to return to a logic 1 after being reset to a logic 0 is measured using software. For example, clock pulses may be counted. That count is related to the time it takes for the output of the multivibrator to return to a logic 1, and is thus related to the resistance value of the potentiometer.

It is known when installing a joystick for the first time, that the joystick must be calibrated. Thus, the user is instructed to move the joystick to a particular position, which is normally the value of minimum resistance, and a time period (count) measured for that resistance value. Thereafter, the user is instructed to move the joystick to another position, typically the position of maximum resistance, and another measurement of the time period (count) is taken for that position. Because the resistance values at those positions are known, and two measurements have been taken, the computer can now determine the resistance value for any position of the joystick.

It is known to use the joystick interface for other purposes. For example, in an article entitled “Thermometer Plus User Manual Version One” appearing at http://www.iconelectron.fsnet.co.uk/thermhelp.htm, a system is disclosed for providing a low cost simple to use method of reading signals derived from external sensors via the game import port on a PC. Similarly, an article entitled “Build a $1.75 Thermometer for your PC” appearing in 16 Bits, describes how a PC's game port may be used for a variety of real world tasks, including the measurement of temperature and humidity. However, like the situation with the joystick, some manual calibration is required. Thus, the need exists for a simple, automated calibration routine that can be performed on sensors attached to a computer's game port.

### BRIEF SUMMARY OF THE DISCLOSURE

In one embodiment, the present disclosure contemplates a system that comprises a personal computer having a game port adapter for producing signals representative of resistance values. A first resistor and a second resistor each having a known resistance value are connected to the game port adapter. A variable resistor having a resistance value that varies in response to an environmental condition is also connected to the game port adapter. A processor is programmed to automatically obtain values (counts) from the adapter for the first resistor, the second resistor and the variable resistor, and to determine a value for the environmental condition based on the obtained values.

In an alternative embodiment, the present disclosure contemplates a method of automatically calibrating an environment sensor connected to a personal computer having a game port adapter. The method comprises: producing a first signal from a first resistor having a first known resistance value; producing a second signal from a second resistor having a second known resistance value; polling a game port adapter to obtain the first and second signals; and determining a relationship between resistance and the first and the second signals.

A system and method according to the present disclosure allow a user to automatically calibrate resistance-based sensors connected to a first joystick input on a computer game port adapter by affixing known resistances to a second joystick input on the game port adapter. The corresponding software first establishes a linear relationship between the known resistances and corresponding adapter voltages (as represented by respective pulse counts). Based on this relationship, the software automatically calibrates the sensor attached to the game port adapter. Using a variable voltage signal (and corresponding variable pulse count) generated by the sensor in response to an environmental condition (e.g., temperature, humidity, etc.), the measured pulse counts of the known resistances, and resistance/environmental condition data provided by the manufacturer of the sensor, a value for the environmental condition can be determined without the need for manual calibration of the sensor. The software also enables the computer to display the value of the current environmental condition sensed by the sensor.

### BRIEF DESCRIPTION OF THE DRAWINGS

For the present disclosure to be easily understood and readily practiced, the present disclosure will now be described, for purposes of illustration and not limitation, in conjunction with the following figures, wherein:

FIG. 1 illustrates a PC upon which the present disclosure may be practiced;

FIG. 1A shows an exemplary game adapter card that may contain necessary hardware and software to interface a joystick or a sensor with the PC shown in FIG. 1;

FIG. 2 illustrates the pin configuration on a fifteen pin game adapter interface socket connector shown in FIG. 1A;

FIG. 3 illustrates an exemplary hardware configuration attached to the socket connector of FIG. 2; and

FIG. 4 illustrates the steps of an example of an auto-calibration methodology according to the present disclosure.

### DETAILED DESCRIPTION OF THE DISCLOSURE

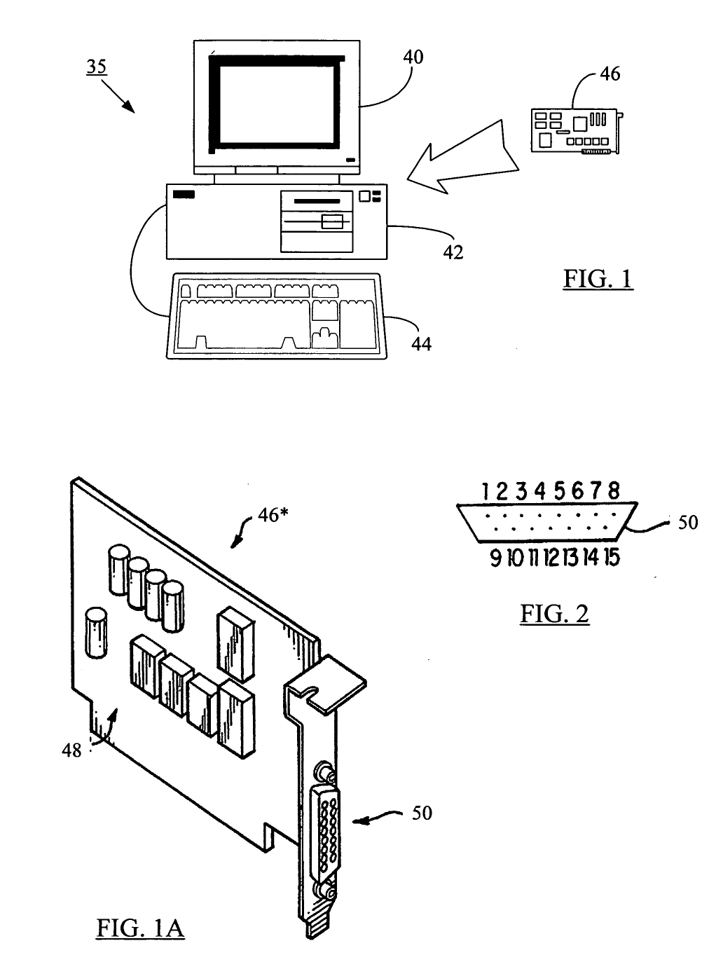

FIG. 1 illustrates a PC (Personal Computer) 35 upon which the present disclosure may be practiced. The PC 35 may be an IBM®-compatible personal computer, a workstation, an Apple® computer, or any other computing device that may be configured to operate a joystick or similar electronic game control device using a suitable game adapter card (discussed later hereinbelow). Furthermore, the PC 35 may operate on a Windows® operating system, a Linux® operating system, or any other suitable operating system as is known in the art. The PC 35 may include a display terminal or monitor 40, a data storage and processing unit 42, and a keyboard or data entry device 44. The display terminal 40 may be attached (not shown) to the data processing unit 42 and may be a CRT display, a flat panel monitor, a touch screen monitor, or any other type of computer display. The keyboard 44 is shown attached to the data processing unit 42 to allow a user to input commands and data into the data processing unit 42 for storage and execution as is known in the art. A pointing device (e.g., a computer mouse) (not shown) may also be attached to the data processing unit 42 as is known in the art.

The data storage and processing unit 42 may include a computer data storage or memory portion (not shown), which may include the computer's on-board RAM (random access memory) and ROM (read only memory) memory units as well as various data storage and retrieval options such as a hard disk drive (HDD), a floppy or CD (compact disk) drive, a DVD (digital video disk) drive, etc. The data processing unit 42 may also include a data processing portion (not shown) to manage data flow and execution between computer's one or more processors (not shown) and computer's internal (e.g., a game adapter card 46) as well as external peripheral units (e.g., the monitor 40 or the keyboard 44). In the embodiment of FIG. 1, the game adapter card 46 is depicted as an internal PC card that may be placed inside the housing of the data processing unit 42 in appropriate slot provided therefor.

FIG. 1A shows an exemplary game adapter card 46* that may contain necessary hardware and software to interface a joystick (not shown) or a sensor (not shown) with the PC 35 shown in FIG. 1. The game adapter card 46* is an exemplary embodiment of the card 46 in FIG. 1 and, hence, is designated by reference numeral “46*” to denote its exemplary nature and functional similarities between the two game adapter cards 46 and 46*. The hardware and software on the game adapter card 46* may be configured to allow interfacing of other peripheral devices as well. The game adapter card 46* may be a printed circuit board (PCB) 48 with a number of general purpose integrated circuit (IC) chips and application-specific integrated circuit (ASIC) chips and other electronic components mounted thereon. The ASIC chips may contain embedded software that may control the joystick interface functionality supported by the card 46*. The software (not shown) and associated hardware on the PCB 48 may allow the data processing unit 42 to electrically communicate with external joysticks (not shown) or sensors (not shown) via a socket connector 50 to which such joysticks or sensors may be attached. The adapter card 46* may function to recognize when a joystick or sensor (not shown) is attached to the card 46* via the connector 50 and convey the relevant identification information to a processor (not shown) in the processing unit 42 to enable the processor to initiate the calibration of such joystick or sensor so as to allow the user to electrically “connect” or interface the joystick or sensor to the PC 35. Further, the processor may interact with the software on the adapter card 46* to facilitate automatic calibration of the joystick or sensor according to the teachings of the present disclosure as provided hereinbelow. Upon calibration, the user may operate the external device (joystick or sensor) and view various data (e.g., temperature measured by the sensor (not shown)) or action parameters (e.g., movement of a cursor using the external joystick (not shown)) on the computer screen 40.

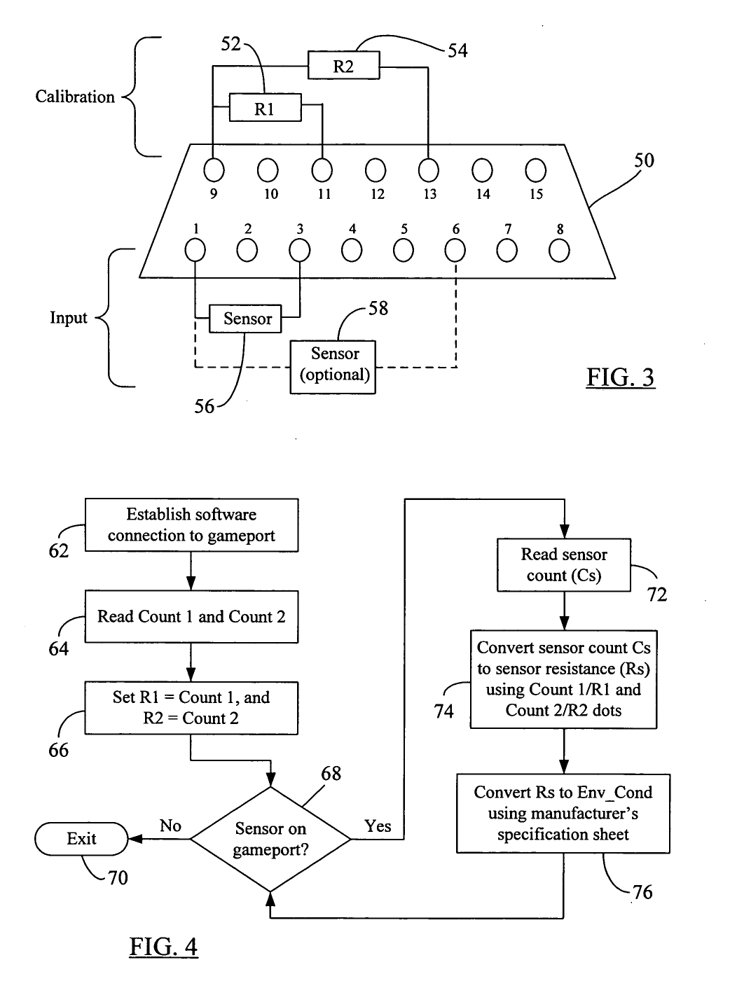

FIG. 2 illustrates the pin configuration on a fifteen pin game adapter interface socket connector 50 shown in FIG. 1A. In one embodiment, this fifteen pin socket connector 50 may be used to interface two joysticks to the PC 35. On the other hand, a joystick expansion unit (not shown) may be connected to the connector 50 to provide interface to more than two joysticks to the PC 35 as is known in the art. A sensor (e.g., a temperature sensor or a humidity sensor) may also be attached to one or more pins of the socket connector 50 (as discussed below with reference to FIG. 3) to provide the user the ability to view the sensor readings on the computer screen 40 and further manipulate those readings (e.g., by storing them or forwarding them to another user, etc.) using the data storage and processing unit 42.

FIG. 3 illustrates an exemplary hardware configuration attached to the socket connector 50 of FIG. 2. In FIG. 3, a first resistor (R1) 52 having a known resistance value is connected between two input pins (e.g., pins numbered 9 and 11) on the socket connector 50. These input pins may correspond to the X-axis inputs had there been a first joystick (not shown) connected thereto for calibration. Similarly, a second resistor (R2) 54 having a second known resistance value is connected between two other input pins (e.g., pins 9 and 13) on the socket connector 50. Again, input pins 9 and 13 may correspond to the Y-axis inputs had there been the first joystick (not shown) connected thereto for calibration. That is, instead of connecting the first joystick and obtaining a relationship between voltages generated by the extreme X and Y positions of the joystick and corresponding resistances (e.g., generated by the joystick's potentiometer (not shown)) in those X and Y positions, the present disclosure contemplates connecting two known resistors R1 and R2 to represent first joystick inputs at the joystick port on the connector 50 as illustrated in FIG. 3.

In FIG. 3, a sensor 56 having a variable resistance is connected between two of the input pins (e.g., pins 1 and 3) that might have been used for the X-axis inputs from a second joystick (not shown) if connected thereto. It is noted here that the variable resistor of the sensor 56 may have a known relationship to an environmental condition (e.g., temperature, humidity, light intensity, etc.). For example, in case of a thermistor as the sensor 56, the thermistor specifications may provide that the thermistor provides 30 KΩ of resistance at 77° F. and 10 KΩ of resistance at 97.5° F. Similarly, other types of sensors may provide corresponding minimum and maximum resistance range for the corresponding operating range of values for the environmental condition the sensors are designed to measure. In addition to the sensor 56, another sensor 58 may optionally be connected to those input pins (e.g., pins 1 and 6 on the connector 50) that may be designated to typically receive the Y-axis inputs from the second joystick (not shown). The attachment of the second sensor 56 may be optional, as is indicated by the dotted lines in FIG. 3. Furthermore, if a certain computer configuration or game adapter card (e.g., card 46*) requires a joystick port/connector 50 to provide joystick inputs in pairs only (e.g., X-Y inputs) so as to be recognized as a valid joystick, then a dummy resistor (of known value) may be connected in place of sensor 58 so as to enable the PC 35 to recognize the sensor 56 during and after calibration.

Thus, instead of connecting two joysticks to the corresponding input pins on the connector 50 (as is typically done during joystick calibration and operation), the embodiment in FIG. 3 utilizes those input pins designated for joystick connections to attach a pair of known resistors (R1 and R2) and one or more sensors 56, 58 in place of the joysticks. It is discussed hereinbelow with reference to FIG. 4 how an automatic calibration of the sensor(s) may be performed using the arrangement shown in FIG. 3. Those of ordinary skill in the art will recognize that the resistors 52 and 54 and the sensors 56, 58 may be connected to other pins on the socket connector 50 without departing from the scope of the present disclosure. For example, the pin locations of the resistors 52, 54 may be switched with those of the sensors 56, 58 without affecting the operation. The particular pins used are merely a matter of preference, as the software for polling the adapter and reading the values can be modified so as to recognize on which pins which values will be found.

FIG. 4 illustrates the steps of an example of an auto-calibration methodology according to the present disclosure. Initially, at block 62, a software connection to the game port adapter 46 is initiated. The operating system in the PC 35 may contact the software (if any) residing on the adapter card 46* to instruct the software to read (through the connector port 50) the values of resistors R1 and R2 (blocks 64 and 66 described below). After the game port connection is established, at block 64, the calibration software routine(s) may read, using appropriate hardware, the potential differences (or voltages) between pins 9 and 11 (voltage V1) and 9 and 13 (voltage V2) to link the voltages read to the known resistances R1 and R2, respectively. It is noted here that, for example, pins 9 and 1 on the connector 50 may provide a steady voltage of +5V. Thus, any change from the +5V threshold due to connection of R1 and R2 to game port connector 50 may be measured by the calibration software using, for example, the clock pulse counting method described hereinbefore under the “Background” section. Thus, the voltage values V1 and V2 may be “measured” in terms of corresponding pulse counts—Count 1 and Count 2. As the software may be provided with the known values of R1 and R2, the measured values of voltages (in terms of respective pulse counts) at block 64 allows the software to establish a relationship between R (resistance) and C (pulse count) parameters. Thus, at block 66, the calibration software assigns Count 1 to the known resistance value R1 and Count 2 to the known resistance value R2. This allows the software to inherently establish two points in an X-Y plane and, hence, a straight line relationship between R and C (representing the voltage parameter (V)) parameters. For example, if R1=30 KΩ produces a pulse count of 800 (C1), and R2=10 KΩ produces a pulse count of 500 (C2), then the software may inherently establish a straight line relationship in the two-dimensional (X-Y) sense linking the two pairs of values, (R1, C1) and (R2, C2). For example, in the foregoing example, an X-Y equation may be given as Y=15*X+350, where variable Y represents pulse counts and variable X represents resistance values (in KΩ). This R-C linear relationship may then be used by the software to later determine the sensor resistance as discussed hereinbelow with reference to block 74. The measurement and subsequent assignment of pulse counts to known resistance values concludes the initial calibration operation at block 66.

It is noted here that, in one embodiment, the known values of R1 and R2 may define the maximum and minimum values, respectively, of resistance that may be recognized by the sensor measurement routine. In that event, the value of Rs at run-time must preferably fall with the R1-R2 range so as to be “recognized” by the program and, hence, to be assigned a corresponding temperature value. However, in another embodiment, the values of R1 and R2 may be just two points (not necessarily the extremes) defining the linear R-Count relationship, which may then be used to assign a corresponding resistance to the Count produced by the variable resister, which resistance can then be used to determine the environmental condition. In this embodiment, the measurement routine may recognize a range of resistance values above and below the range defined by R1 and R2.

A current environmental condition (Env_Cond) measurement (e.g., measurement of current room temperature) routine is illustrated in FIG. 4 with reference to blocks 68, 70, 72, 74, and 76. At step 68, a decision is made as to whether a sensor (e.g., a thermistor as sensor 56) of the type illustrated in FIG. 3 is connected to the game port adapter 46* (via connector 50). If not, the program exits at block 70. However, if a sensor is found connected to the game port adapter, the pulse count (Cs) corresponding to the value of sensor resistance (Rs) (not shown—which is a variable resistance whose value varies according to the environmental condition (e.g., temperature, humidity, etc.) being sensed—is read at block 72. In this step, the pulse count Cs is measured to later determine the sensor resistance (Rs) as discussed below with reference to block 74. Thus, a change from the threshold voltage (e.g., +5 V) due to Rs may be measured in terms of corresponding pulse counts Cs and then the pulse counts Cs may be assigned to “represent” the value of Rs to the measurement routine.

At block 74, the value of Rs is obtained by converting its corresponding pulse count Cs into an associated resistance value using the linear relationship between resistance (R) and pulse count (C) parameters established by the pair of values (R1, C1) and (R2, C2). As noted before, the R1-C1 and R2-C2 pairs of values allow the calibration and measurement software to establish a straight line in X-Y plane—a two-dimensional linear equation—linking R and C parameters, which may be consulted by the software to obtain or “look up” the value of resistance that corresponds to the measured pulse count Cs. This resistance value may then be assigned to the sensor resistance (Rs). For example, if the sensor pulse count Cs is 650, then from the X-Y equation given hereinbefore with respect to an exemplary embodiment, the value of Rs may be computed as Rs=(650−350)/15=20 KΩ. Similarly, the software may compute other values of the variable resistance Rs generated throughout the operating range of the sensor.

After the current value of the sensor's internal variable resistance Rs (which varies according to the environmental condition being sensed) is determined at block 74, the measurement routine may convert the determined value of Rs into the corresponding value of the environmental condition (Env_Cond) so as to enable the computer 35 to display (or present in any suitable manner) the value of the environmental condition to the user (block 76). As part of the conversion process, the software may consult the manufacturer's specification sheet for the specific sensor 56 stored in the computer's memory (not shown) to “look up” the value of environmental condition associated with the determined value of Rs. For example, the manufacturer's specification sheet may provide that the sensor 56 may provide a resistance Rs=20 KΩ when the ambient temperature being sensed (the Env_Cond) is equal to 87° F. In that case, the value of 87° F. may be displayed on the computer screen 40 for the user to view or, alternatively, the software may provide this and other run-time environmental condition values (Env_Cond) to another program or data processing unit for further processing as desired by the user. In this manner, the current environmental condition may be continuously monitored by the measurement routine so long as the sensor 56 is on the game port (decision block 68).

Thus, as shown in FIG. 4, rather than ending the software execution at the calibration routine (blocks 62, 64, and 66), the calibration routine may lead right into the measurement routine (blocks 68, 70, 72, 74, and 76). In one embodiment, a recalibration may be performed each time a measurement is to be taken. Alternatively, the calibration routine may be ended and the measurement routine may be performed a plurality of times thereafter without requiring recalibration.

It is seen from the above discussion that the use of a known pair of resistors as a first set of joystick inputs allows for auto-calibration of sensor(s) attached to the second set of joystick inputs on a game adapter card connector as illustrated by the “calibration” and “input” designations in FIG. 3. In calibrating a sensor input value, the user may not need to manually place the sensor in two different configurations so that the calibration software may recognize corresponding joystick voltage values so as to associate those values with sensor resistance values and, hence, eventually with the environmental condition values corresponding to the sensor resistance values. Furthermore, according to the present auto-calibration methodology, the user may not need to perform the manual calibration on each computer receiving a sensor. Because of the values of R1 and R2 used for calibration are fixed and constant, the auto-calibration may be performed (for a sensor to be calibrated using those R1 and R2 values) on any computer the user wishes to operate as sensor receiver, regardless of the need to change any computer parameters or modify the calibration and measurement software routines.

It is observed that the known resistors R1, R2, and the sensor(s) may be provided as part of a single package that may be attached to the game adapter card connector 50 (FIG. 3) or as a kit of individual elements that may be separately attached to the connector at proper pin locations. Furthermore, the software or program routines for calibration and current environmental condition measurement may be provided on a data storage medium (e.g., a floppy disk or a compact disk) to be installed in the computer 35 (FIG. 1). Alternatively, the user or purchaser of the sensor may be authorized to download the software or program routines into the computer 35 from a communication network (e.g., the Internet) (not shown). It is also possible to supply the calibration components (i.e., the known resistors R1 and R2) and the input components (i.e., one or more sensors), and the associated program routines in suitable other manners as well (e.g., all hardware and software supplied in one transaction or two separate transactions, the software and hardware provided pre-installed with a computer purchase, etc.).

The auto-calibration methodology according to the present disclosure may be implemented with low-cost resistance-based sensors used by hobbyists or for commercial purpose. For example, by using an entire network of such sensors, it may be possible to create applications in many areas such as fire-evacuation planning, corporate energy usage monitoring, computer machine environment monitoring, etc.

While the present disclosure has been described in connection with preferred embodiments thereof, those of ordinary skill in the art will recognize that many modifications and variations are possible. The present disclosure is intended to be limited only by the following claims and not by the foregoing description which is intended to set forth the presently preferred embodiment.

What is claimed is:

1. A system, comprising:
a personal computer having a game port adapter for producing signals representative of resistance values;
a first resistor having a known resistance value, said first resistor connected to said game port adapter;
a second resistor having a known resistance value, said second resistor connected to said game port adapter;
a variable resistor, a resistance value of said variable resistor varying in response to an environmental condition, said variable resistor connected to said game port adapter; and
a processor programmed to automatically obtain values from said adapter for said first resistor, said second resistor and said variable resistor, and to determine a value for said environmental condition based on said obtained values.

2. The system of claim 1 wherein said environmental condition is temperature.

3. The system of claim 1 wherein said environmental condition is humidity.

4. The system of claim 1 wherein said environmental condition is illumination intensity.

5. The system of claim 1 wherein said first resistor is connected between a source of voltage and a first joystick resistor input on said adapter, said second resistor is connected between a source of voltage and a second joystick resistor input on said adapter, and said variable resistor is connected between a source of voltage and a third joystick resistor input on said adapter.

6. A method of automatically calibrating an environment sensor connected to a personal computer having a game port adapter, said method comprising:
producing a first signal from a first resistor having a first known resistance value;
producing a second signal from a second resistor having a second known resistance value;
polling a game port adapter to obtain said first and second signals; and
determining a relationship between resistance and an environmental condition using said first and said second signals.

7. The method of claim 6 wherein said first and said second signals include a count of clock pulses, and wherein said determining includes setting a count of clock pulses representative of said first signal equal to said first known resistance, and setting a count of clock pulses representative of said second signal equal to said second known resistance.

8. The method of claim 6 additionally comprising:
producing a variable signal from a variable resistor having a variable resistance value that varies in response to said environmental condition;
polling the game port adapter to obtain said variable signal; and
determining a value for said environmental condition based on said variable signal and said first and said second signals.

9. A method of operating an environmental sensor connected to a personal computer having a game port adapter at the time that an environmental condition is measured, said method comprising:
producing a first signal from a first resistor having a first known resistance value;
producing a second signal from a second resistor having a second known resistance value;
producing a variable signal from a variable resistor having a resistance that varies in response to said environmental condition;
polling a game port adapter to obtain said first, said second, and said variable signals;
determining a relationship between said first signal, said second signal, and resistance values; and
using said relationship to calculate a value for said environmental condition from said variable signal.

10. A system comprising:
means for providing a first known resistance value, a second known resistance value, and a variable resistance value that varies with an environmental condition;
means for providing a first signal and a second signal corresponding to said first and said second known resistance values, respectively, and a variable signal corresponding to said variable resistance value;
means for storing a first relationship between said first and said second known resistance values and said first and said second signals; and
means for determining a second relationship between said variable signal and said environmental condition based on said first relationship.

11. The system of claim 10, further comprising:
means for providing a known relationship between said variable resistance value and said environmental condition, wherein said means for determining a second relationship being responsive to said means for providing a known relationship.

12. A combination, comprising:
a pair of known resistors including a first resistor and a second resistor having known first and second resistance values, wherein said pair of known resistors is configured to be connected to a game port adapter at input locations designated to receive inputs from a first joystick; and
a set of program instructions configured to be executed by a computer having said game port adapter, wherein said program instructions, upon execution, cause said computer to perform the following:
access said game port adapter and obtain a first signal and a second signal representative of said first resistor and said second resistor, respectively, when said first and said second resistors are connected to said game port adapter, and store a relationship between said first and said second signals and said first and said second known resistance values, respectively.

13. The combination of claim 12, further comprising:
a sensor that is configured to be connected to said computer game port adapter at input locations designated to receive inputs from a second joystick, wherein said sensor is configured to sense an environmental condition and generate a variable resistance value, and wherein said program instructions, upon execution, cause said computer to further perform the following:
access said game port adapter and obtain a variable signal representative of said variable resistance value when said sensor is connected to said game port adapter, and
determine a value for said environmental condition based on said variable signal and said relationship.

14. A program code, which, upon execution by a computer, causes said computer to perform a method comprising:
accessing a game port adapter and obtaining a first measured signal and a second measured signal respectively representative of a first known resistor having a first resistance value and a second known resistor having a second resistance value connected to said game port adapter;
identifying a first relationship between said first and said second measured signals and said first resistance value and said second resistance value, respectively; and
storing said first relationship.

15. The program code of claim 14 which, upon execution by said computer, causes said computer to perform a method further comprising:
accessing said game port adapter and obtaining a variable signal representative of a variable resistance value generated by a sensor connected to said game port adapter upon sensing an environmental condition; and
determining a value for said environmental condition sensed by said sensor based on said variable signal, said first relationship, and a second relationship between resistance and said environmental condition.
